(19) United States
(12) Patent Application Publication
(10) Pub. No.: US 2018/0004729 A1
(43) Pub. Date: Jan. 4, 2018

(54) STATE MACHINE BASED CONTEXT-SENSITIVE SYSTEM FOR MANAGING MULTI-ROUND DIALOG

(71) Applicant: SHENZHEN GOWILD ROBOTICS CO., LTD., SHENZHEN (CN)

(72) Inventors: Nan QIU, SHENZHEN (CN); Haofen WANG, SHENZHEN (CN)

(21) Appl. No.: 15/694,917

(22) Filed: Sep. 4, 2017

Related U.S. Application Data
(63) Continuation-in-part of application No. PCT/CN2016/087769, filed on Jun. 29, 2016.

(51) Int. Cl. G06F 17/27; G10L 15/22; G10L 15/18

(52) U.S. Cl. CPC G06F 17/2785; G10L 15/1822; G10L 15/22; G06F 17/2705; G10L 15/1815; G10L 2015/223

(57) ABSTRACT

The present invention discloses a state machine based context-sensitive multi-round dialog management system, comprising: an input module, for receiving multi-modal input information from a user; an intention identification engine module, for identifying intention information in the multi-modal input information; an intention module, for bringing multiple intention information identified by the intention identification engine module into one-to-one correspondence with multiple intention sub-modules at back ends; a state machine module, comprising a plurality of state machines for managing a relevant context in the dialog management system and providing support for an output result; an instruction parsing engine module, comprising a plurality of instruction parsing engine sub-modules for parsing corresponding intention information and acquiring the parsed multiple intention information; and an output module, for acquiring policy information according to the results from the parsing engine module and the intention identification module, and transmitting the policy information to the state machine module.

### RELATED APPLICATIONS

This is a continuation-in-part application of International Application PCT/CN2016/087769, with an international filing date of Jun. 29, 2016, which is incorporated herein by reference in its entirety.

### FIELD OF THE INVENTION

The present invention relates to a dialog management system, in particular to a state machine based context-sensitive multi-round dialog management system and method.

### BACKGROUND OF THE INVENTION

Communicating with a user in a chat manner is one of necessary functions of a robot. A chat robot is a program using a natural language to simulate a human language to have a dialog with human. From the perspective of application scenarios, the chat robot can be divided into five kinds: online service, amusement, education, personal assistant, and intelligent question and answer. No matter what kind of the above-described chat robot, multi-round interaction is an unavoidable scenario in the chatting process between a robot and human, for example, the omission of the content in the above of a dialog, the use of a pronoun and an idiom and the like. Therefore, a dialog management module is an extremely important part of a human-machine dialog system.

The role of the human-machine dialog system is in a constant evolve process. A robot assistant only does what a user asks, and the next evolve stage of the human-machine interaction is a knowledgeable expert: the user expresses a shallow requirement; the robot guides the user to communicate continuously according to the shallow requirement of the user, digs the real requirement of the user, determines how to specifically satisfy the requirement of the user, and actively recommends according to the preference of the user.

The multi-round interaction is the most important part of an input dialog system, is not only suitable for the input dialog system, but also applies to all the scenarios in a dialog management mode. Most of existing dialog management methods are constructed on the basis of rules, such as the slot filling method, finite automaton method and the like. Such kind of rule-guided human-machine dialog models are successfully applied in business.

The statistical model based dialog management technology comprises: the Bayesian network, a graphical model, a dialog-based enhanced learning technology, a partially observable Markov decision process (POMDP) and the like, such that a computer can flexibly process an input error of a user during human-machine dialog. Compared to the conventional rule-based dialog model, the statistical model based dialog management technology gives a larger degree of freedom to the user during dialog. And due to the degree of freedom, the calculation complexity of the statistical method is also higher. Several acceleration technologies are put forward and reduce the time complexity to a certain extent. However, a multi-modal dialog management process is required to comprehensively consider the fusion of a plurality of signals such as input information, expression, attitude and the like. Therefore, the human-machine dialog system completely based on a statistical model is still hard to be applied in practical human-machine interaction.

Another method is using the slot filling method to realize dialog management. Slot filling method regards the dialog process as a slot filling process, and performs interaction constantly until the dialog target is realized. Each slot corresponds to an entry of a form in a database, so the slot filling method is also called as form filling method. The entry of a form also corresponds to a cell of a semantic frame. The dialog process of the slot filling method is comparatively mechanical, and has a comparatively low human-machine interaction natural degree. However, the slot filling method has a comparatively low realization complexity, and is easy to be developed into a mature commercially practical system.

Still another method is the realization of a finite state machine model which generally adopts an event driven method, an event table driven method, and an object oriented method, wherein the event driven method can determine which state transition function will be executed according to the current state of the system and an occurred event, and utilize a conditional branch technology to automatically switch the state of the system. The event table driven method can create an event driven table on the basis of an event driver, wherein the table comprises the current state of the system, a trigger event, the next state, and state transition functions. Such a system can search out the corresponding state transition function and the next state from the event driven table according to the current state and the trigger event, and execute the state function to perform state transition. The object oriented design method configures an attribute for each state in a state diagram, and can execute a certain operation (the state transition function) when a trigger event is received. Therefore, each state can be a class; the state attribute can be denoted with the member variables of the class; and the state transition function can be realized by the member functions of the class.

The realization method establishing a finite state machine model regards the dialog process as the state transition process of an automaton, and the main tasks thereof are designing the state and state transition condition of the automaton. Such a method has a clear clew. However, the uncertainty of the user model is high; the described automaton transition condition is too complex; and the definition of state is not very clear.

Therefore, it is necessary to find a method for ensuring the effective ongoing of a dialog between a computer and a person. The dialog management module is an extremely important part of the dialog system. Therefore, the core content of dialog management is guiding the smooth ongoing of human-machine interaction through policy control. And the tasks thereof are comprehensively analyzing a language understanding result, the context knowledge of a dialog and historical information to determine the intention of the user, searching a background database as required, organizing a proper answer sentence, and ensuring the dialog between a computer and a person to keep on going effectively and amiably, until the intent of the user is realized.

The present invention seeks for mutual understanding through an indirect or direct speech behavior, the initiation of a new dialog round, dialog clarification and correction, a historical context record, pragmatic information and the like. Particularly in a real time input dialog system, when the input information is identified erroneously or the information provided by the user is incomplete, the dialog management module can lead the user to smoothly complete human-machine interaction.

### OBJECTS AND SUMMARY OF THE INVENTION

The present invention discloses a state machine based context-sensitive multi-round dialog management system, comprising: an input module, for receiving multi-modal input information from a user; an intention identification engine module, for identifying intention information in the multi-modal input information; an intention module, for bringing multiple intention information identified by the intention identification engine module into one-to-one correspondence with multiple intention sub-modules at back ends; a state machine module, comprising a plurality of state machines for managing a relevant context in the dialog management system and providing support for an output result; an instruction parsing engine module, comprising a plurality of instruction parsing engine sub-modules for parsing corresponding intention information and acquiring the parsed multiple intention information; and an output module, for acquiring policy information according to the results from the parsing engine module and the intention identification module, and transmitting the policy information to the state machine module.

Preferably, the state machine module comprises a first state machine and a second state machine.

Preferably, the first state machine is configured to complete a context of the intention identification engine module, and provide the completed context for the intention identification engine module to re-identify unknown intention information.

Preferably, the second state machine is configured to complete a context of the intention module, and provide the completed context for the instruction parsing engine module to re-parse the intention information.

Preferably, the number of the second state machine corresponds to the number of the intention information.

Preferably, the first state machine is further configured to manage the second state machine.

Preferably, the first state machine is further configured to receive the policy information provided by the output module, and providing context information to provide support for an output result.

A state machine based context-sensitive multi-round dialog management method, comprising: an input module receives multi-modal input information; an intention identification engine module identifies intention information in the multi-modal input information; an intention module brings multiple intention information identified by the intention identification engine module into one-to-one correspondence with multiple intention sub-modules at back ends; a state machine module manages a relevant context in the dialog management system, and provides support for an output result; an instruction parsing engine module parses the intention information; and an output module acquires policy information according to the results from the parsing engine module and the intention identification module, and transmits the policy information to the state machine module.

A state machine based context-sensitive multi-round dialog management system, comprising an input device, a processor, an output controller and an output device, wherein:

the input device is configured to receive multi-modal input information input by a user, and comprises a microphone, an analog-to-digital converter, a voice identification processor, an image acquisition device and an image processor; the microphone, the analog-to-digital converter and the voice identification processor are sequentially connected; the microphone is configured to acquire a voice signal of the user when the user and a robot are dialoging; the analog-to-digital converter is configured to convert the voice signal into voice digital information; the voice identification processor is configured to convert the voice digital information into word information, and input the word information into the processor; the image acquisition device is configured to acquire an image containing the user; and the image processor is configured to identify and acquiring user information from the image containing the user, and input the user information into the processor;

The processor comprises an intention identification engine module, an intention module, a state machine module, an instruction parsing engine module and an output module;

The intention identification engine module is configured to identify intention information in the multi-modal input information;

The intention module comprises intention sub-modules for bringing multiple intention information identified by the intention identification engine module into one-to-one correspondence with multiple intention sub-modules at back ends;

The instruction parsing engine module comprises a plurality of instruction parsing engine sub-modules for parsing corresponding intention information and acquiring the parsed multiple intention information;

The output module is configured to acquire policy information according to the result from the instruction parsing engine module, and transmit the policy information to the state machine module;

The state machine module comprising a plurality of state machines for managing a relevant context in the dialog management system and providing support for completing context information for the intention identification engine module, the intention module, the instruction parsing engine module, and the output module; and

The output controller selects the intention information which conforms to the real intention of the user from the intention information parsed out by the plurality of instruction parsing engine sub-modules according to the policy information output from the output module, generates output information, and controls the output device to output corresponding information to the user according to the output information.

An existing robot can only search for an answer in a pre-designed “question-answer library” according to a literal meaning, and give a mechanical answer. However, in different scenarios, the same sentence spoken by the user may have different meanings which may denote two completely different intentions of the user. The existing human-machine interaction technology cannot identify the intention of the user, and thus cannot distinguish the different intentions of the same sentence. The state machine based context-sensitive multi-round dialog management system provided by the second embodiment comprehensively analyzes a language understanding result, the context knowledge of a dialog and historical information to determine the intention of the user, searches in a background database as required, and organizes a proper answer sentence, such that the robot can understand the content of the dialog, and can give a reply and an action which conform to the intention of the user to the most extent, thus improving the reply accuracy of the robot to the user, improving the experience of the user during human-machine interaction, and enabling the user to accept the practicability and personification of the robot. Particularly in a real time input dialog system, under the circumstances that the input information is identified erroneously or the information provided by the user is incomplete, the robot can still correctly understand the intention of the user, such that the human-machine interaction can keep on going smoothly.

During human-machine interaction, a state machine of the state machine based context-sensitive multi-round dialog management system records all the interaction information which contains the idioms, special nicknames of the user and a corresponding relationship between a tone and an intention. On the basis of the stored personal user information, the state machine of the state machine based context-sensitive multi-round dialog management system can give a feedback and an action which conform to user habits still better in the process of adding a farmer for the user by combining state machines and context scenarios, thus further improving the intimacy between a robot and human during interaction.

### BRIEF DESCRIPTION OF FIGURES

In order to illustrate the technical schemes in the embodiments of the present invention or in the prior art more clearly, the drawings which are required to be used in the description of the embodiments or the prior art are briefly described below. It is obvious that the drawings described below are only some embodiments of the present invention. It is apparent to those of ordinary skill in the art that other drawings may be obtained based on the accompanying drawings without inventive effort.

FIG. 1 is a module diagram of the state machine based context-sensitive multi-round dialog management system according to the first embodiment of the present invention;

FIG. 2 is a flow chart of the state machine based context-sensitive multi-round dialog management method according to the first embodiment of the present invention;

FIG. 3 is a flow chart of the state machine based context-sensitive multi-round dialog management method for identifying input voice information according to the first embodiment of the present invention;

FIG. 4 is a module diagram of the state machine based context-sensitive multi-round dialog management system according to the second embodiment of the present invention; and

FIG. 5 is an application scenario of the state machine based context-sensitive multi-round dialog management system according to the second embodiment of the present invention.

### DETAILED DESCRIPTION OF THE EMBODIMENTS

The technical scheme of the present invention will be further described in details in combination with drawings and specific embodiments. It is apparent that the described embodiments are only a part of the embodiments of the present invention, but not the whole. Based on the embodiments of the present invention, all the other embodiments obtained by those of ordinary skilled in the art without inventive effort are within the scope of the present invention.

First of all, a state machine model is utilized to construct a system dialog flow, and then a slot filling result is taken as a system state transition condition. One time of state transition of the state machine corresponds to one basic dialog unit (namely a statement block formed by a user question and a machine answer) in the dialog process; one state entry action corresponds to one user question in the basic dialog unit; one state machine event corresponds one machine answer; one state transition action corresponds to one time of user command parameter parsing (a natural language processing module acquires a command and a parameter, and interacts with a parameter authentication module to acquire a parameter authentication result).

In addition, a plurality of skill packages are processed in parallel, and the processing processes of the modules are asynchronous. Therefore, the system is provided therein with a plurality of finite state machines which are distinguished from each other via special identifiers. And the plurality of finite state machines are maintained and managed by one state machine.

A dialog management module is in interaction with one or more skill package processors. And each skill package processor possesses required knowledge and processing logics in the art, and searches in a knowledge library for required information according to the information requirement of a user. If the searched information is found missing, then the required information will be completed with the slot filling method. If the required information still cannot be fully completed, then an interaction mode will be adopted, wherein the interaction mode consists of a question and answer mode and an option mode.

### First Embodiment

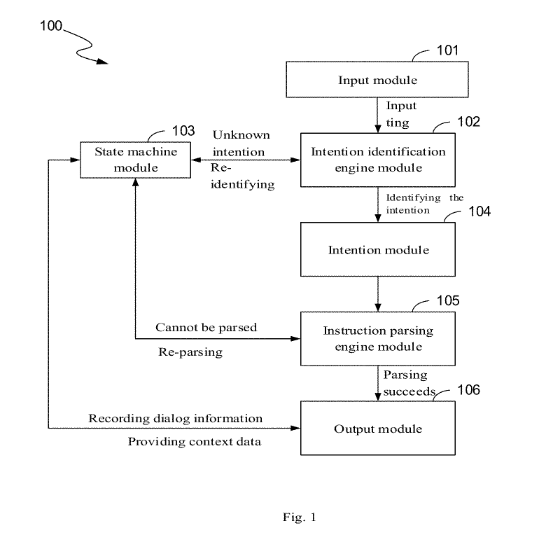

FIG. 1 is a module diagram of the state machine based context-sensitive multi-round dialog management system 100 according to the first embodiment of the present invention. As shown in FIG. 1, the dialog management system 100 comprises an input module 101, an intention identification engine module 102, a state machine module 103, an intention module 104, an instruction parsing engine module 105 and an output module 106, wherein the input module 101 is configured to receive input information and identifying the meaning of the input information; the input information herein can be multi-modal input information which comprises but not limited to the information of a video, a human face, an expression, a scenario, a voice print, a fingerprint, iris pupil, photosensitive information and the like; after the input information is received, the identified input information is input into the intention identification engine module 102; the intention identification engine module 102 is configured to identify intention information in the input information; if the intention information contained in the input information can be identified, then the intention identification engine module 102 transmits the identified multiple intention information to the intention module 104 to execute the next step; otherwise, the intention identification engine module 102 transmits the input information to the state machine module 103; the state machine module 103 comprises a plurality of state machines for managing context information in the dialog management system, for example, the relevant context of the intention identification engine module, and the relevant context of the intention module, wherein a first state machine is further configured to manage a second state machine (the functions of the first state machine and the second state machine will be elaborated later); in addition, the first state machine further provides support for the final output result.

In one embodiment, the first state machine receives the input information the intention of which is not identified out, completes the context according to the input information, and transmits the input information having completed the context to the intention identification engine module 102 again for re-identification, until the intention information in the input information is identified out.

Further, after the intention module 104 receives the identified multiple intention information, the intention module 104 corresponds all the intention information to multiple intention sub-modules. In one embodiment, the identified intention information comprises a plurality of different intention meanings. Then the various intention information is transmitted to the instruction parsing engine module 105 for parsing, wherein each intention information corresponds to one instruction parsing engine sub-module of the instruction parsing engine module 105. If the intention information is successfully parsed, then the parsed intention information is transmitted to the output module 106; otherwise, the intention information which is not successfully parsed is transmitted to the state machine module 103; the state machine module 103 completes the context, and transmits the intention information which is not successfully parsed and the context completed thereby to the instruction parsing engine module 105 for re-parsing until the intention information is successfully parsed. The output module 106 is configured to output policy information according to the parsed multiple intention information, and generate output information according to the policy information, wherein the output information comprises dialog information. Furthermore, the output module 106 transmits the output information to the state machine module 103; and the state machine module 103 returns a feedback to the output module according to the context information and the dialog information to prepare for outputting a result.

In one embodiment, a plurality of intentions are identified out during intention identification, in which case the plurality of intentions will be transmitted to a plurality of intention sub-modules, and processed by corresponding instruction parsing engine sub-modules; the processing result of each instruction parsing engine sub-module is independent; and the output module comprehensively evaluates (for example, adopting a scoring policy or other policies) the plurality of independent results, and outputs one result. The result herein is not always a result, but only denotes a next step policy or a next step processing, namely policy information; to be more specific, the result is configured to guide the next step: to keep on going or ask the user a question; the input information is stored in the state machine module, and the state machine module provides support for the final output result.

In one embodiment, the state machine module (to be specific, the first state machine of the state machine module) provides support for an output result. For example, as for the final output result, the self-evaluated scores and results fed back by the modules (the state machine module in FIG. 1 comprises a plurality of state machines which are unshown in FIG. 1) are A; the weight that the intention identification engine module provides for the intention sub-modules is B; the weight of the intention sub-modules mentioned in previous rounds of dialogs (the closer to the current dialog, the greater the weight is) is C; the weight artificially added on the basis of experience or a model is D; the four weights or scores A, B, C and D are comprehensively considered to calculate and rank the comprehensive score of each module (each intention sub-module); if the scores ranking ahead (the first, the second, the third . . . ) are comparatively close, then a policy 1 is adopted; and if the first and the second ranking ahead have a large gap, then a policy 2 is adopted. Policy 1 can be but not limited to: if the first is a story module and the second is a music module, then feeding back “Do you want to listen to a story or a music?” to the user. Policy 2 can be but not limited to: if the comprehensive score of the first is far greater than the second, then directly outputting the result of the module corresponding to the first. Context is only an example to illuminate how the state machine module provides support for an output result, but not used to limit the present invention.

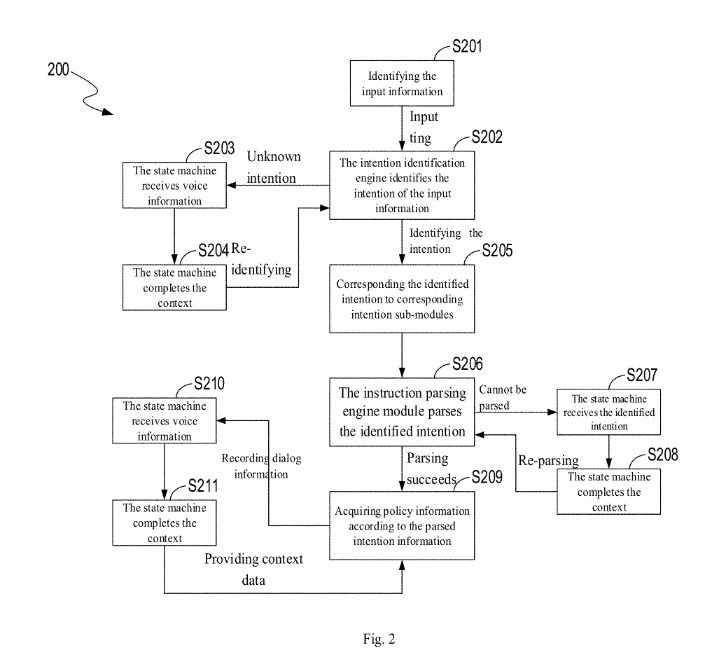

FIG. 2 is a flow chart 200 of the state machine based context-sensitive multi-round dialog management method according to the first embodiment of the present invention; FIG. 2 will be described in combination with FIG. 1.

Step S201, after a user inputs an instruction, first identifying input information.

Step S202, inputting the input information into the intention identification engine module to perform intention identification; if the intention identification engine module identifies the intention of the instruction according to the acquired input information, then execute step S203: namely inputting the input information into the first state machine (which is a state machine of the state machine module, roughly the same hereafter), and then execute step S204: after the state machine module completes the context information, re-inputting the completed context information into the intention identification engine module to perform intention identification. After intention identification engine module identifies the intention information, execute step S205: namely corresponding the identified intention information to corresponding intention sub-modules, wherein the identified intention may comprise multiple intention information. Next, execute step S206: transmitting the plurality of intention information having corresponded to corresponding intention sub-modules to the instruction parsing engine module, and parsing the plurality of intention information, wherein each intention information is transmitted to one instruction parsing engine sub-module for parsing; if the instruction parsing engine sub-module successfully parses the corresponding intention information, then execute step S209: namely integrating all the successfully parsed intention information, acquiring policy information, and returning the policy information to the state machine module. Otherwise, execute step S207: namely transmitting all the intention information which is not successfully parsed to the state machine module (the second state machine of the state machine module); then execute step S208: the state machine module completes the context information, re-inputs into the instruction parsing engine module for re-parsing, until all the intention information is successfully parsed.

Further, step S210, the state machine module (namely the first state machine of the state machine module) receives the policy information, and records the present round dialog information. Step S211, the state machine completes the context, and provides the context information for the output module for processing next step. In one embodiment, the first state machine provides support for an output result according to the policy information.

In one embodiment, the input information in the context can be but not limited to voice information, text information, image information and the like. For example, the information in the above is: what's the weather like today? And the question is: tomorrow? Literally, the specific meaning of “tomorrow?” cannot be determined, in which case the data is completed according to the information in the above to generate a complete sentence: “what's the weather like tomorrow?” For another example, the existing information is: play “Journey to the West” episode 3; and the following question is “play the next episode”. Through analysis, firstly, it is known that a song is titled as “the next episode”; secondly, when a story series is being played, “play the next episode” when the current state is not story on-demand, playing the next episode will switch to the next episode. Therefore, a rule is firstly established as follows: when the current state is not story on-demand, “play the next episode” means to play the song “the next episode”; and when the current state is the story on-demand, “play the next episode” means to play the next episode of story.

To be specific, the input module transmits “play the next episode” to the intention identification engine module; the intention identification engine module processes and transmits the “play the next episode” to a music on-demand module and a story on-demand module; the music on-demand module parses out the result “play the song ‘the next episode’”; the story on-demand module queries the state machine thereof, for example, the queried current state is playing “Journey to the West” episode 3, so the story on-demand module will parse out the result “play ‘Journey to the West’ episode 4”. The music on-demand module and the story on-demand module both confidently transmit the self-evaluated scores thereof to the output module. When the output module finds out that the self-evaluated scores of the music on-demand module and the story on-demand module are the same, the output module will query the master state machine.

The state machine gives different weight scores according to previous dialogs. The previous dialog is about story on-demand (“Journey to the West” episode 3”), so the score of the story on-demand module is greater than the score of the music on-demand module.

The output module accepts the output of the story on-demand module as the output “play ‘Journey to the West’ episode 4” thereof according to the weights given by the master state machine,

The descriptions above are only preferred embodiments when referring to the text in the above or the text in the following, but not intended to limit the present invention. In practice, the state machine based context-sensitive multi-round dialog management system can process the input information on the basis of the text in the above only, or the text in the following, or both the text in the above and the text in the following (namely the context), and finally output a more accurate output result.

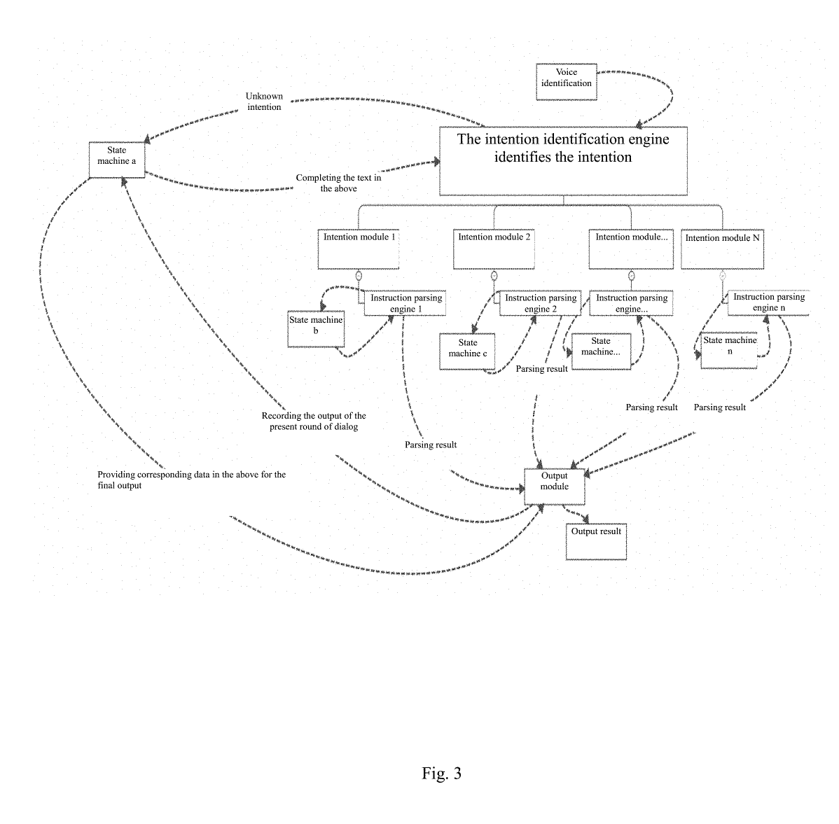

FIG. 3 is a flow chart of the state machine based context-sensitive multi-round dialog management method for identifying input voice information according to the embodiment of the present invention. And the embodiment mainly describes how to acquire output information by completing the information in the above. FIG. 3 is a supplementary description to the flow chart of FIG. 2, and will be described in combination with FIG. 1 and FIG. 2. In order to avoid redundancy, the modules executing the same functions will not be repeated here. As shown in FIG. 3, the intention module 1 and the intention module N correspond to the intention module 104 in FIG. 1, can be understood as the N number of intention sub-modules of the intention module 104, and are respectively configured to identify each intention information of the user, wherein one intention information corresponds to one intention sub-module. Similarly, the instruction parsing engine 1 and the instruction parsing engine n correspond to the instruction parsing engine module 105 in FIG. 1, can be understood as the n number of instruction parsing engine sub-modules of the instruction parsing engine module 105, and are respectively configured to parse each intention information of the user, wherein one intention information corresponds to one instruction parsing engine. The state machine a the state machine n in FIG. 3 correspond to the state machine module 103 in FIG. 1, wherein the state machine a (namely the first state machine) manages the relevant state (context) of the intention identification engine module 102; and the state machines b, c, d (namely the second state machine) respectively manage the relevant states (context) of the intention module 1 and the intention module N.

In one embodiment, the input module consists of state machines, and is configured to input, identify and correct error (or eliminating ambiguity). For example, “What can be used to chongji”: according to the acquired input information, the input information which is voice information here may have a plurality of understandings, such as “appease one's hunger” or “impact” which have the same pronunciation in Chinese. In this case, the state machine module can acquire a reasonable result with the ambiguity eliminated by combining the context and the state scenario of the interaction. For example, if the context is related to “food”, “fatigue” and the like, then “chongji” can be understood as “appease one's hunger”.

It shall be noted that the input information, the intention and the instruction, whether identified or parsed successfully or not, shall all complete the state machine flow; when successful, the successfully parsed data is transmitted to the state machine for management; and when not successful, the context information is acquired from the state machine to complete data.

The state machine manages the intention identification engine module in a similar manner. When the user inputs “turn up a little”, no one knows whether the user wants to control a household electrical appliance or control the volume. In this case, context is acquired via the state machine; if the context is related to a household electrical appliance, then the input information is considered to be transmitted to a household electrical appliance module; or the probability to be transmitted to the household electrical appliance module is higher. And the instruction parsing engine module is also processed with the same processing method.

### Second Embodiment

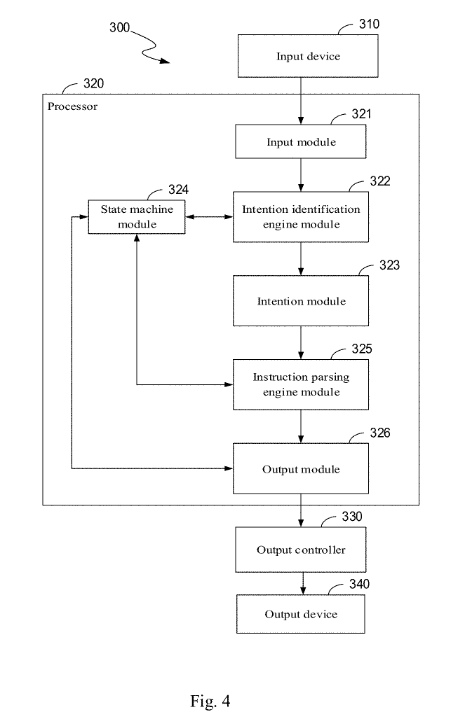

FIG. 4 shows the state machine based context-sensitive multi-round dialog management system 300 according to the second embodiment. The system 300 comprises an input device 310, a processor 320, an output controller 330 and an output device 340.

The input module 310 is configured to receive multi-modal input information from a user; The input device 310 comprises but not limited to the following devices: a word input device (a key board, a touch screen and the like), a voice identification device, an image acquisition and identification device, an optical sensor, an iris identification sensor, a fingerprint acquirer sensor, a temperature sensor, a heart rate sensor and the like, thus enriching the information input mode of the user. The multi-modal input information comprises one or more of word information, voice information, image information, photosensitive information, pupil iris information, fingerprint information, body temperature information, heart rate information and the like. The intention identification engine module can further identify the expression information of the user, the environment of the user, the gesture information of the user and the like according to the image information, thus further enriching the categories of the multi-modal input information, and improving intention identification accuracy. For example, the voice identification device comprises a microphone, an analog-to-digital converter, a voice identification processor, wherein the microphone is configured to acquire a voice signal of the user when the user and a robot are dialoging; the analog-to-digital converter is configured to convert the voice signal into voice digital information; the voice identification processor is configured to convert the voice digital information into word information, and input the word information into the processor 320. The image acquisition and identification device comprises an image acquisition device and an image processor, wherein the image acquisition device is configured to acquire an image containing the user; and the image processor is configured to process the image containing the user, identify and acquire the expression information of the user, the environment of the user, the gesture information of the user and the like which can also be input into the processor 320 as multi-modal input information.

The processor 320 comprises an input module 321, an intention identification engine module 322, an intention module 323, a state machine module 324, an instruction parsing engine module 325 and an output module 326.

The input module 321 is configured to receive and correspondingly pre-processing the multi-modal input information acquired by the input device 310. Preferably, the input module 321 can identify and correct the error of the multi-modal input information according to the context provided by the state machine module. The specific process can refer to relevant content in the first embodiment, and will not be repeated here.

The intention identification engine module 322 is configured to identify intention information in the multi-modal input information.

The intention module 323 comprises intention sub-modules for bringing multiple intention information identified by the intention identification engine module into one-to-one correspondence with multiple intention sub-modules at back ends.

The instruction parsing engine module 325 comprises a plurality of instruction parsing engine sub-modules for parsing corresponding intention information and acquiring the parsed multiple intention information.

The output module 326 is configured to acquire policy information according to the result from the instruction parsing engine module, and transmit the policy information to the state machine module.

The state machine module 324 comprising a plurality of state machines for managing a relevant context in the dialog management system and providing support for completing context information for the input module, the intention identification engine module, the intention module, the instruction parsing engine module, and the output module, wherein the input information, the intention and the instruction, whether identified or parsed successfully or not, shall all complete the state machine flow; when successful, the successfully parsed data is transmitted to the state machine for management; and when not successful, the context information is acquired from the state machine to complete data, so as to complete parsing according to the completed data. The specific operation processes of the state machines can refer to the content of the state machine based context-sensitive multi-round dialog management method and system in the first embodiment, and will not be repeated here.

The state machine module comprises a first state machine and a second state machine, wherein the first state machine is configured to complete a context of the intention identification engine module, and provide the completed context for the intention identification engine module to re-identify unknown intention information; and the second state machine is configured to complete a context of the intention module, and provide the completed context for the instruction parsing engine module to re-parse the intention information. The number of the second state machine corresponds to the number of the intention information. The first state machine is further configured to manage the second state machine.

The processing process of each module of the processor 320 can refer to the content of the state machine based context-sensitive multi-round dialog management method and system in the first embodiment, and will not be repeated here.

Alternatively, the processor 320 can be a central processing unit (CPU), an application specific integrated circuit (ASIC), a field-programmable gate array (FPGA), or a complex programmable logic device (CPLD).

The stored context comprises multiple states of the state machines, the chat information with the user and the like.

The output controller 330 selects the information which conforms to the real intention of the user from the intention information parsed out by the plurality of instruction parsing engine sub-modules according to the policy information output from the output module, generates output information, and controls the output device to output corresponding information to the user according to the output information, wherein the output information comprises a control instruction or dialog information. When the user wants to control a device and the output information contained in the policy information is a control instruction, an intelligent household electrical appliance is controlled to operate. When the user wants to interact and chat with the robot, the system outputs reasonable dialog information on the basis of the context information in the state machine, so as to realize a multi-round dialog during human-machine interaction.

The output device 340 comprises at least one of a display device, a voice playing device and an intelligent household electrical appliance. The system 300 can give a proper feedback according to the context stored in the state machine module, and output the feedback to the user via the display device or the voice playing device, wherein the feedback can be a voice feedback, an expression feedback, an image feedback and the like. The intention input by the user can also be controlling an intelligent household electrical appliance, in which case the system 300 can infer which intelligent household electrical appliance the user wants to control according to the context stored in the state machines of the state machine module, and output a control instruction to a corresponding intelligent household electrical appliance according to the intention of the user.

The system further comprises a wireless communication device 350 via which the output controller transmits a control instruction to each output device.

Alternatively, the output controller 330 can be a central processing unit (CPU), an application specific integrated circuit (ASIC), a field-programmable gate array (FPGA), or a complex programmable logic device (CPLD).

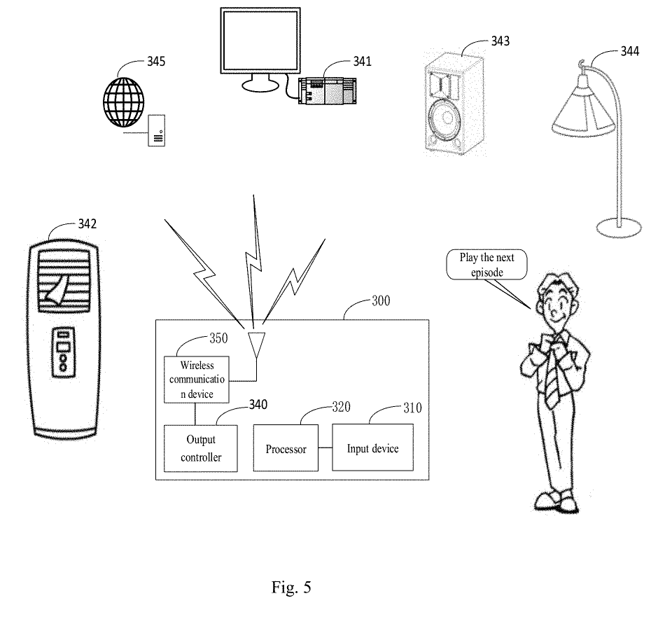

FIG. 5 shows an application scenario of the system 300 provided by the second embodiment. By using the state machine based context-sensitive multi-round dialog management system 300 provided by the second embodiment, a user not only can have a multi-round dialog with an intelligent robot, but also can realize intelligent control to an intelligent household electrical appliance on the basis of a multi-round dialog technology. The specific flow of the state machine based context-sensitive multi-round dialog management method has been elaborated in the above-described method embodiment, and will not be repeated here. For example, the input device 310 acquires that the instruction input by the user is “play the next episode”; the existing information acquired by the processor 320 is that a video playing device 341 is playing “Journey to the West” episode 3; through analysis, the processor 320 learns that a song is titled as “the next episode”; when the current state is not story on-demand, “play the next episode” means to play the song “the next episode”; and when the current state is the story on-demand, “play the next episode” means to play the next episode of story. The processor 320 derives the control instruction of “play the next episode of story” by combining the above-described rules and the existing information, and transmits the control instruction to the video playing device 341 via the wireless communication device. With the same method, the user can control indoor intelligent household electrical appliances via the state machine based context-sensitive multi-round dialog management system 300, such as an air conditioner 342, a loudspeaker cabinet 343, an intelligent lamp 344 and the like, and can even realize other various intelligent control modes by connecting an Internet 345.

An existing robot can only search for an answer in a pre-designed “question-answer library” according to a literal meaning, and give a mechanical answer. However, in different scenarios, the same sentence spoken by the user may have different meanings which may denote two completely different intentions of the user. The existing human-machine interaction technology cannot identify the intention of the user, and thus cannot distinguish the different intentions of the same sentence. The state machine based context-sensitive multi-round dialog management system provided by the second embodiment comprehensively analyzes a language understanding result, the context knowledge of a dialog and historical information to determine the intention of the user, searches in a background database as required, and organizes a proper answer sentence, such that the robot can understand the content of the dialog, and can give a reply and an action which conform to the intention of the user to the most extent, thus improving the reply accuracy of the robot to the user, improving the experience of the user during human-machine interaction, and enabling the user to accept the practicability and personification of the robot. Particularly in a real time input dialog system, under the circumstances that the input information is identified erroneously or the information provided by the user is incomplete, the robot can still correctly understand the intention of the user, such that the human-machine interaction can keep on going smoothly.

During human-machine interaction, a state machine of the system 300 records all the interaction information which contains the idioms, special nicknames of the user and a corresponding relationship between a tone and an intention. On the basis of the stored personal user information, the system 300 can give a feedback and an action which conform to user habits still better in the process of adding a farmer for the user by combining state machines and context scenarios, thus further improving the intimacy between a robot and a person during interaction.

The disclosure above is only the preferred embodiments of the present invention, but not intended to limit the protection scope of the present invention. Therefore, any equivalent variations made according to the claims of the present invention are all concluded in the protection scope of the present invention.

What is claimed is:

1. A state machine based context-sensitive multi-round dialog management system, comprising:
an input module, for receiving multi-modal input information from a user;
an intention identification engine module, for identifying intention information in the multi-modal input information;
an intention module, for bringing multiple intention information identified by the intention identification engine module into one-to-one correspondence with multiple intention sub-modules at back ends;
a state machine module, comprising a plurality of state machines for managing a relevant context in the dialog management system and providing support for an output result;
an instruction parsing engine module, comprising a plurality of instruction parsing engine sub-modules for parsing corresponding intention information and acquiring the parsed multiple intention information; and
an output module, for acquiring policy information according to the results from the parsing engine module and the intention identification module, and transmitting the policy information to the state machine module.

2. The state machine based context-sensitive multi-round dialog management system according to claim 1, wherein the state machine module comprises a first state machine and a second state machine.

3. The state machine based context-sensitive multi-round dialog management system according to claim 2, wherein the first state machine is configured to complete a context of the intention identification engine module, and provide the completed context for the intention identification engine module to re-identify unknown intention information.

4. The state machine based context-sensitive multi-round dialog management system according to claim 2, wherein the second state machine is configured to complete a context of the intention module, and provide the completed context for the instruction parsing engine module to re-parse the intention information.

5. The state machine based context-sensitive multi-round dialog management system according to claim 4, wherein the number of the second state machine corresponds to the number of the intention information.

6. The state machine based context-sensitive multi-round dialog management system according to claim 2, wherein the first state machine is further configured to manage the second state machine.

7. The state machine based context-sensitive multi-round dialog management system according to claim 2, wherein the first state machine is further configured to receive the policy information provided by the output module, and provide context information to provide support for an output result.

8. A state machine based context-sensitive multi-round dialog management method, comprising the steps of:
an input module receiving multi-modal input information;
an intention identification engine module identifying intention information in the multi-modal input information;
an intention module bringing multiple intention information identified by the intention identification engine module into one-to-one correspondence with multiple intention sub-modules at back ends;
a state machine module managing a relevant context in the dialog management system, and provides support for an output result;
an instruction parsing engine module parsing the intention information; and
an output module acquiring policy information according to the results from the parsing engine module and the intention identification module, and transmitting the policy information to the state machine module.

9. The state machine based context-sensitive multi-round dialog management method according to claim 8, wherein the state machine module comprises a first state machine and a second state machine.

10. The state machine based context-sensitive multi-round dialog management method according to claim 9, wherein the first state machine is configured to complete a context of the intention identification engine module, and provide the completed context for the intention identification engine module to re-identify unknown intention information.

11. The state machine based context-sensitive multi-round dialog management method according to claim 9, wherein the second state machine is configured to complete a context of the intention module, and provide the completed context for the instruction parsing engine module to re-parse the intention information.

12. The state machine based context-sensitive multi-round dialog management method according to claim 11, wherein the number of the second state machine corresponds to the number of the intention information.

13. The state machine based context-sensitive multi-round dialog management method according to claim 9, wherein the first state machine is further configured to receive the policy information provided by the output module, and provide context information to provide output support for an output result.

14. A state machine based context-sensitive multi-round dialog management system, comprising an input device, a processor, an output controller and an output device, wherein:
the input device is configured to receive multi-modal input information input by a user;
the input device comprises a microphone, an analog-to-digital converter, a voice identification processor, an image acquisition device and an image processor;
the microphone, the analog-to-digital converter and the voice identification processor are sequentially connected;
the microphone is configured to acquire a voice signal of the user when the user and a robot are dialoging;
the analog-to-digital converter is configured to convert the voice signal into voice digital information;
the voice identification processor is configured to convert the voice digital information into word information, and input the word information into the processor;
the image acquisition device is configured to acquire an image containing the user;
the image processor is configured to identify and acquire user information from the image containing the user, and input the user information into the processor;
the processor comprises an intention identification engine module, an intention module, a state machine module, an instruction parsing engine module and an output module;
the intention identification engine module is configured to identify intention information in the multi-modal input information;
the intention module comprises intention sub-modules for bringing multiple intention information identified by the intention identification engine module into one-to-one correspondence with multiple intention sub-modules at back ends;
the instruction parsing engine module comprises a plurality of instruction parsing engine sub-modules for parsing corresponding intention information and acquiring the parsed multiple intention information;
the output module is configured to acquire policy information according to the result from the instruction parsing engine module, and transmit the policy information to the state machine module;
the state machine module comprises a plurality of state machines for managing a relevant context in the dialog management system and providing the support for completing context information for the intention identification engine module, the intention module, the instruction parsing engine module and the output module; and
the output controller selects the intention information which conforms to the real intention of the user from the intention information parsed out by the plurality of instruction parsing engine sub-modules according to the policy information output from the output module, generates output information, and controls the output device to output corresponding information to the user according to the output information.

15. The system according to claim 14, wherein:
the processor further comprises an input module;
the input module is configured to receive multi-modal input information from the input device, and identify and correct the error of the multi-modal input information according to the context provided by the state machine module.

16. The system according to claim 14, wherein the state machine module comprises a first state machine and a second state machine.

17. The system according to claim 16, wherein the first state machine is configured to complete a context of the intention identification engine module, and provide the completed context for the intention identification engine module to re-identify unknown intention information.

18. The system according to claim 16, wherein the second state machine is configured to complete a context of the intention module, and provide the completed context for the instruction parsing engine module to re-parse the intention information.

19. The system according to claim 16, wherein the number of the second state machine corresponds to the number of the intention information.

20. The system according to claim 16, wherein the first state machine is further configured to manage the second state machine.
